(19) United States
(12) Patent Application Publication
(10) Pub. No.: US 2009/0106337 A1
(43) Pub. Date: Apr. 23, 2009

(54) Serial Adder Based On "No-Carry" Addition

(76) Inventor: Rada Ruth Higgins, Amsterdam (NL)

Correspondence Address: RADA HIGGINS, KEIZERSGRACHT 63 B, AMSTERDAM, 1015 CE, NL

(21) Appl. No.: 11/379,793

(22) Filed: Apr. 23, 2006

(51) Int. Cl. G06F 7/503

(52) U.S. Cl. 708/232; 708/234

(57) ABSTRACT

The invention, based on an original addition algorithm for adding two binary numbers, a and b, and disclosed in the body of this application, is a schematic diagram of a serial, synchronous, digital adder, with circuitry which exemplifies an unusual procedure for calculating the carry at any bit pair, aᵢ and bᵢ, and is not based on a recursive function of the carry, cᵢ₋₁. The operation of “adding” defined in the algorithm is one, in which there is no obvious “addition” at all, as classically defined, and which may or may not eventually become applicable in future or other technologies (besides that of the digital computer), as those technologies develop or come to light. The invention also encompasses designs for modified data registers.

### DISCLOSURES

The operation of adding two binary numbers, b=bₙbₙ₋₁. . . b₀ and a=aₙaₙ₋₁ . . . a₀, has traditionally been broken down into three steps: firstly, for a given i, computing the sum, say, sᵢ, of a bit pair, bᵢ and aᵢ; secondly, computing the carry, cᵢ₋₁, from the sum of the two preceding bits, aᵢ₋₁ and bᵢ₋₁, respectively, and, thirdly, adding the carry to the sum, sᵢ. The second embodiment demonstrates a synchronous, digital, serial Adder based on a different way of adding, an “addition,” in which there is no “adding,” as we know it, at all, and which is defined entirely in terms of the operation of isolating L-blocks of 1 digits (called an “L-tree,” for present purposes) among the set of (column) pairs (bᵢ, aᵢ) of the augend and addend and then taking complements. In the algorithm given below, named here, the Higgins' Binary Addition Algorithm (© 1991 R. Higgins, Dec. 17, 1990, The Netherlands), the procedure is explained and will be shown to be equivalent to binary addition.

An aspect of the invention(s), considered an improvement of prior art for serial Adders, with the possible exception of “transistor” technology, comprises the “carry circuit,” (first embodiment) embedded within the Adder(s) and applied unconventionally in the second embodiment. The carry circuit comprises less hardware than that of the prior art, which comprises 3 And gates and 1 Or gate plus a clocked D Flip Flop, to store the “carry.” The “carry circuit” disclosed in this preferred embodiment essentially uses 1 clocked RS Flip Flop.

The “addition embodied in the invention is based on the following transformation, L, where L is defined on every pair of bits, aᵢ and bᵢ: by the association L: bᵢ? bᵢcᵢ₋₁ and L: aᵢ? (aᵢ^{c}cᵢ₋₁+aᵢbᵢ^{c}cᵢ₋₁^{c}). We can write the binary numbers, a=aₙaₙ₋₁. . . a_{0 and b=b}ₙbₙ₋₁ . . . b₀ as two row vectors:

bₙbₙ₋₁ . . . b₀

aₙaₙ₋₁ . . . aₐ

In the following addition algorithm the definition of an “L-tree” is given, upon which the above transformation is based. The above equations give a mathematical description of the operation of replacing each bit which is part of an “L-tree with its complement.

### Binary Addition Algorithm

Consider the sum of two binary numbers, a=aₙ . . . a₂a₁a₀ and b=bₙ . . . b₂b₁b₀ and imagine b, the augend, in a row above a, the addend. Step 1. If bₖ in b is greater than aₖ in a, then interchange aₖ with bₖ, giving a=aₙ . . . bₖ . . . a₂a₁a₀ and b=bₙ . . . a_{k . . .} b₂ b₁b₀ Do this for every value of k. The procedure is to find beginning positions and end positions of blocks of 1's in “a.” For every 1ᵣ in “b,” define an L-tree as follows: 1ᵣ corresponds either to a 0ᵣ in “a,” where 0ᵣ is a “0” at the rₜₕ position in “a.” In this case, the tree is defined to be “degenerate.” Or, in the other case, 1ᵣ in “b” corresponds to 1ᵣ, i.e., a “1” at the r^{th} position, in a. In this case, this is the start of a non-degenerate L-tree. The second 1 extends possibly to another 1 to its left, i.e., of the next higher subscript in “a,” and so forth until the first 0 bit is reached. When 0 is reached, the L-tree is complete. Although not for discussion here, it is apparent that there is a correspondence between L-trees and binary numbers of the form 1+2 +2²+2³+ . . . +2ⁿ=2ⁿ⁺¹−1

Starting at the index 0 in b, and working from b₀ to bₙ, take the complement of every bit in the first L-tree found, including a degenerate one. If bᵣ is the start of the tree, then, after taking complements, it will become 0. If s is the first subscript where aₛ=0, then aₛ will become 1. And for r<j<s, aⱼ will also become 0.

Proceed on to the next 1 digit in b, of subscript higher than that of the last bit In the previous L-tree. At the next 1 bit in b, construct the L-tree, as before, and take the complements of the bits in the L-tree. Continue the above procedure until the last sub script, n, is reached. All that will be left over are degenerate L-trees. Repeat the above procedure for all of these trees, also. After this second step, we will have b=0ₙ₊₁0ₙ . . . 0₀ and a, in the lower row, will be the sum of a+b.

### Proof:

This algorithm can be proved by induction on the length n of the strings a and b. For the case, n=1, we have a=a₁a₀ and b=b₁b₀. There are four possibilities for a and b, 00,10, 01, 11. We can eliminate the case where b=00, as no L-tree can be formed in this case and the sum of a and b is a, by definition of the number 0. Consider the case a=10 and b=01, for example. Then there is one degenerate L-tree from 1 to 0 at subscript 1. Interchanging 1 and 0, we get b=00 and a=11, the sum of the original a and b. Consider the case, b=11 and a=11. Then there exists an L-tree from subscript 0 to 2 (where a₂ and b₂ both=0), giving the numbers b=10 and a=100, after taking complements. There is still a degenerate L-tree at subscript 1. Taking complements leaves b=00 and a=110, the sum of 11 and 11. Similar arguments will hold for all remaining cases.

Next, assume the algorithm is true for all binary strings of length n or less.

Let (eₙ, eₙ₋₁, . . . ,e₀) and (dₙ, dₙ₋₁, . . . ,d₀) be binary numbers of length n+1 in Zⁿ⁺¹, where Z={0,1}. Then eᵢ=min (eᵢ, dᵢ) and dᵢ=max (eᵢ, dᵢ).

The induction assumption is that for binary numbers, say, (d)=(dₙ₋₁, dₙ₋₂, . . . , d₀) and (e)=(eₙ₋₁, eₙ₋₂, e₀) of length n, and for all L-trees of length=n, (where an L-tree is defined as eₖ=1 and dₖ=1 and dⱼ₍ₖ₎=0 and dₛ=1 for k=s<j (k), with j (k)−k+1=n ) the theorem holds true. If for any (d) and (e) an L-tree is of length n+1, then e₀=1 and dₖ=1 for k=0, . . . , n−1 and the theorem holds true, by normal addition, because (e)+(0,1,1, . . . ,1)=(1,0,0, . . . ,0)+(eₙ, eₙ₋₁, . . . , e₁, 0) since e₀. . . 1. And thus (e)+(d)=(1,eₙ₋₁, eₙ₋₂, . . . 3₁, 0)

Consider (d) and (e) in Zₙ₊₁. If all the L-trees in (d) and (e) are of length=n+1, then the theorem holds true, because all the L-trees partition (d) and (e) into disjoint sections of bits, all of which can be embedded isomorphically in Zⁿ, as seen in the example below: In the sum,

(e)=(eₙ, . . . , eₖ₍ⱼ₍ₛ₎₎. . . ,eₖ₍ⱼ₎, . . . ,e_{k(j-1)(s)|1}, eₖ₍ⱼ₋₁₎₍ₛ₎, . . . eₖ₍ⱼ₋₁₎, . . . ,e_{k(1(s)|1},eₖ₍₁₍ₛ₎₎, . . . eₖ₍₁₎, . . . , e₀)

plus

(d)=(dₙ, . . . , dₖ₍ⱼ₍ₛ₎₎. . . ,dₖ₍ⱼ₎, . . . ,dₖ₍ⱼ₋₁₎₍ₛ₎₊₁, dₖ₍ⱼ₋₁₎₍ₛ₎, . . . dₖ₍ⱼ₋₁₎, . . . ,dₖ₍₁₍ₛ₎₊₁,dₖ₍₁₍ₛ₎₎, . . . dₖ₍₁₎, . . . ,d₀)

where eₖ₍ᵣ₎=1, r=1, 2, . . .j and eₖ₍ᵣ₍ₛ₎₎=0 and dₖ₍ᵣ₎₊ⱼ=1 for 0=j =k(r(s))−1 and dₖ₍ᵣ₍ₛ₎₎=0. We can embed each section from subscript k(r) to k(r(s)), r=1, . . . , j, isomorphically, into Zⁿ by adding a sufficient number of 0's before and after the section, as follows: (0, . . . ,eₖ₍ᵣ₍ₛ₎₎, eₖ₍ᵣ₍ₛ₎₎₋₁, . . . eₖ₍ᵣ₎, . . . 0) and (0, . . . ,d_{k(r(s)), d}ₖ₍ᵣ₍ₛ₎₎₋₁, . . . dₖ₍ᵣ₎, . . . . 0) in Zⁿ. Moreover, these sections are disjoint, meaning no “carry” is carried forth from one (isomorphic) section to another (isomorphic) section. Therefore, we can apply the induction assumption to these binary strings in Zⁿ The left-over sections in (e) and (d) can also be embedded in Zⁿ in a similar fashion and, applying the associative law of addition, the induction assumption applies to the total sum of all the sections, which is isomorphic to the sum of (e) and (d).

The last cases to consider is when there is an L-tree of length n+1 or length n+2 . Consider (d)=(0,1 . . . 1,1) of length n+1. Then since eₙ=0 and e₀=1, we obtain, by normal addition, we obtain (e)+(d)=(1, eₙ₋₁, eₙ₋₂, . . . , e₁, 0)

If there is an L-tree of length n+2, then we have (0, eₙ, eₙ₋₁, . . . e₁, 1) and (0,1,1,1, . . . , 1,1) in Zⁿ⁺². We can write (0,1,1,1, . . . ,1,1) as ( 0,1, 0, . . . ,0)+(0,0,1,1, . . . 1). Therefore, (d)+(e)=[(0, eₙ, eₙ₋₁, . . . e₁, 1)+(0,0,1,1, . . . ,1)]+(0,1, 0, . . . 0)=[(0, eₙ, eₙ₋₁, . . . e₁, 0)+(0, 1, 0, . . . 0)]+(0, 1, 0, . . . ,0)=(0, eₙ, eₙ₋₁, . . . e₁, 0)+[(0, 1, 0, . . . ,0)+(0, 1, 0, . . . ,0)]=(0, eₙ, eₙ₋₁. . . e₁, 0)+(1,0,0, . . . 0)=(1, eₙ, eₙ₋₁, . . . e₁, 0) QED Therefore, by induction, the algorithm is proved.

### Second Proof:

As mentioned above, Min (eᵢ, dᵢ)=eᵢdᵢ and Max (eᵢ, dᵢ)=eᵢ+dᵢ Therefore, given

(e)=(eₙ,eₙ₋₁, . . . ,e₀)

+(d)=(dₙ, dₙ₋₁, . . . ,d₀)

we have, by definition of the L-tree transform,

L(eᵢ)=(eᵢdᵢ)cᵢ₋₁

and L(dᵢ)=(eᵢ+dᵢ)^{c}cᵢ₋₁+(eᵢ+dᵢ)(eᵢdᵢ)^{c}cᵢ₋₁^{c}

Therefore, the sum (eᵢ)+(dᵢ)=

$$( {e}_{i} {d}_{i} ) {c}_{i - 1} + {( {e}_{i} + {d}_{i} )}^{c} {c}_{i - 1} + ( {e}_{i} + {d}_{i} ) {( {e}_{i} + {d}_{i} )}^{c} {c}_{i - 1}^{c} = ( {e}_{i} {d}_{i} ) {c}_{i - 1} + {e}_{i}^{c} {d}_{i}^{c} {c}_{i - 1} + ( {e}_{i} + {d}_{i} ) ( {e}_{i}^{c} + {d}_{i}^{c} ) {c}_{i - 1}^{c} = ( {e}_{i} {d}_{i} ) {c}_{i - 1} + {e}_{i}^{c} {d}_{i}^{c} {c}_{i - 1} + [ {e}_{i} {d}_{i}^{c} + {d}_{i} {e}_{i}^{c} ] {c}_{i - 1}^{c} = ( {e}_{i} {d}_{i} ) {c}_{i - 1} + {e}_{i}^{c} {d}_{i}^{c} {c}_{i - 1} + {e}_{i} {d}_{i}^{c} {c}_{i - 1}^{c} + {d}_{i} {e}_{i}^{c} {c}_{i - 1}^{c}$$

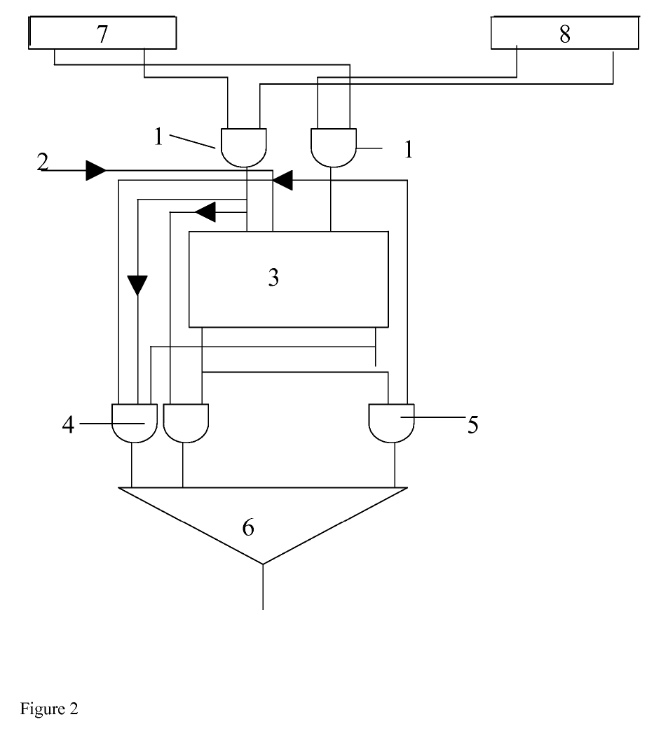

a well-known formula. Q.E.D.
(It can also be shown that L(eᵢ) and L(dᵢ) are not both non-zero, hence the max of the two expressions is equivalent to the inclusive OR or sum of the two expressions, as expressed in the invention of FIG. 2.)

In accordance with the invention is provided a digital, synchronous, serial adder comprising two AND gates, or equivalently, an AND gate and an OR gate, the output terminal of each of which is applied to the data input terminals of an RS Flip Flop. A clock signal with an inverter is also applied to said RS Flip flop, in which one of whose output terminals is stored the carry of two corresponding bits of two respective binary numbers. Each output terminal of said flip flop is applied to two of four additional AND gates. The output terminal of each said four additional AND gates is applied to an OR gate, wherein the sum of two corresponding bits of two respective binary numbers is stored, in response to a predetermined first clock signal. (In an additional embodiment, one output terminal of said flip flop is applied to an additional AND gate and its other output terminal is applied to two AND gates. The output terminal of each said three AND Gates is applied to an OR gate, wherein the sum of two corresponding bits of two Respective binary numbers is stored, in response to a predetermined first clock signal.)

When a clock signal reaches a high state, signals from the data register are applied to the ADDER, some of which pass through 2 AND gates (or equivalently, an AND and an OR gate), whose terminals connect with the RS FF, which is unresponsive to the signals, because of the inverter on the clock pulse line, which only allows a zero current to flow into both terminals.

During this period, the input signals to the flip flop are both zero, freezing the content of the flip flop, which has been stored from the previous Not-clock signal period (and which is identical, coincidentally, to the i−1^{th} carry of the bits, aᵢ₋₁ and bᵢ₋₁). These stored signals from the previous not-clock signal combine with the signals from the above said gates to produce outputs which are returned respectively to B-Register or A-Register.

One advantage of the invention is the “carry” circuit, which uses fewer components than background art; also, the Adder contains less components than related-art serial adders (FIGS. 2, 3 and 4).

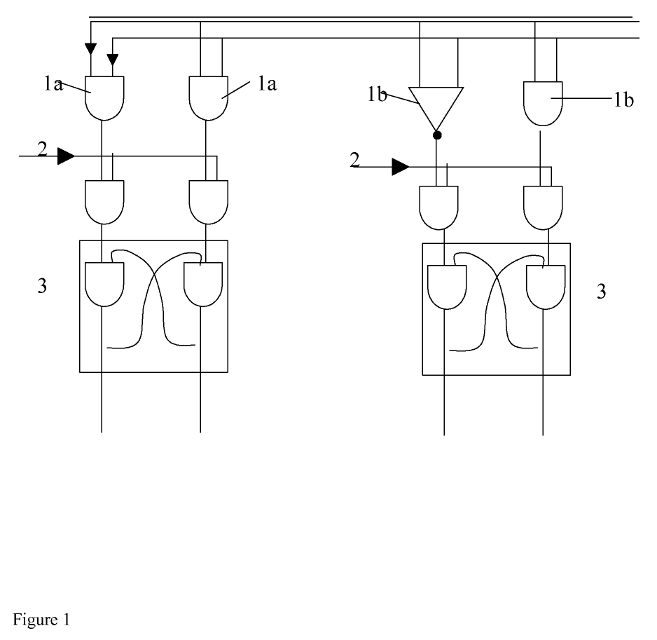

Optionally and additionally, there are two latch-based Registers ideally linked with said Adder which allows it to perform addition faster. When the clock signal is at a high state and when a data signal, b₀, is concurrently being applied to the input terminal of the first unit (D-Flip Flop) of the B-Register (FIG. 1), a line from the input terminal of said first D-Flip Flop of the B-Register to the appropriate And gates of the Adder enables the signal, b₀, to be applied directly in addition, simultaneously to being applied to the B-Register. When the clock signal is at a high state and when a data signal, b₀, is being applied to the input terminal of the said first unit of the B-Register, then if concurrently an output signal, a₀, from the A-Register is being applied to the Adder, then their sum signal, s₀, can be computed before the B-Register has been filled.

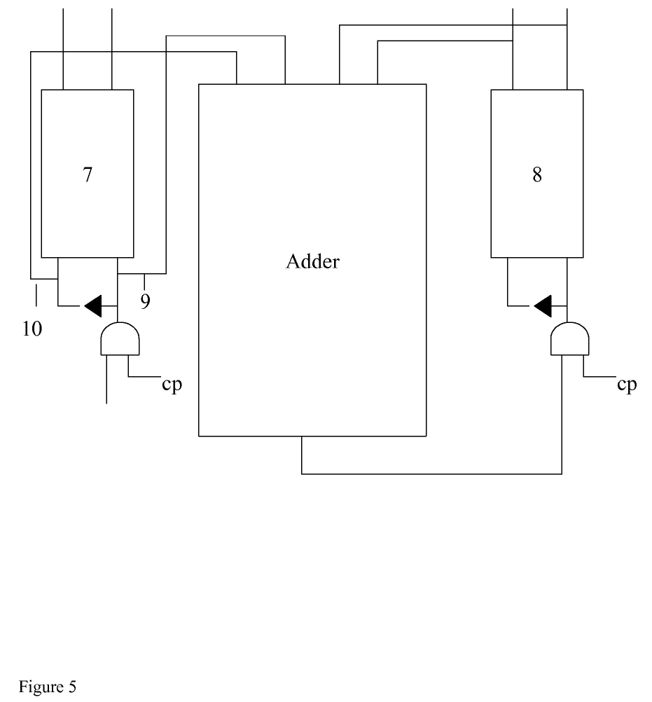

It only remains to show that the clocked Flip Flop, as defined in this invention and depicted in FIG. 5, computes the carry. That it does can be demonstrated by constructing Truth Tables with all possible values (shown on the following page. (For the purpose of this demonstration the clock pulse line with inverter can be disregarded.)

| State = | | | | | | | | |
|---|---|---|---|---|---|---|---|---|
| preceding | | | | | | | | |
| carry | aᵢ | bᵢ | aᵢ^{c} | bᵢ^{c} | R = a^{c}b^{c} | S = ab | Qᵢ | Cᵢ |
| 0 | 0 | 0 | 1 | 1 | 1 | 0 | 0 | 0 |
| 0 | 0 | 1 | 1 | 0 | 0 | 0 | 0 | 0 |
| 0 | 1 | 0 | 0 | 1 | 0 | 0 | 0 | 0 |
| 0 | 1 | 1 | 0 | 0 | 0 | 1 | 1 | 1 |

| State = | | | | | | | | |
|---|---|---|---|---|---|---|---|---|
| preceding | | | | | | | | |
| carry | aᵢ | bᵢ | aᵢ^{c} | bᵢ^{c} | R = a^{c}b^{c} | S = ab | Qᵢ | Cᵢ |
| 1 | 0 | 0 | 1 | 1 | 1 | 0 | 0 | 0 |
| 1 | 0 | 1 | 1 | 0 | 0 | 0 | 1 | 1 |
| 1 | 1 | 0 | 0 | 1 | 0 | 0 | 1 | 1 |
| 1 | 1 | 1 | 0 | 0 | 0 | 1 | 1 | 1 |

FIG. 1 is a schematic diagram of a carry circuit embodying the principles of the present invention.

FIG. 2 is a schematic diagram of a serial Adder but with a carry circuit embodying the principles of the present invention.

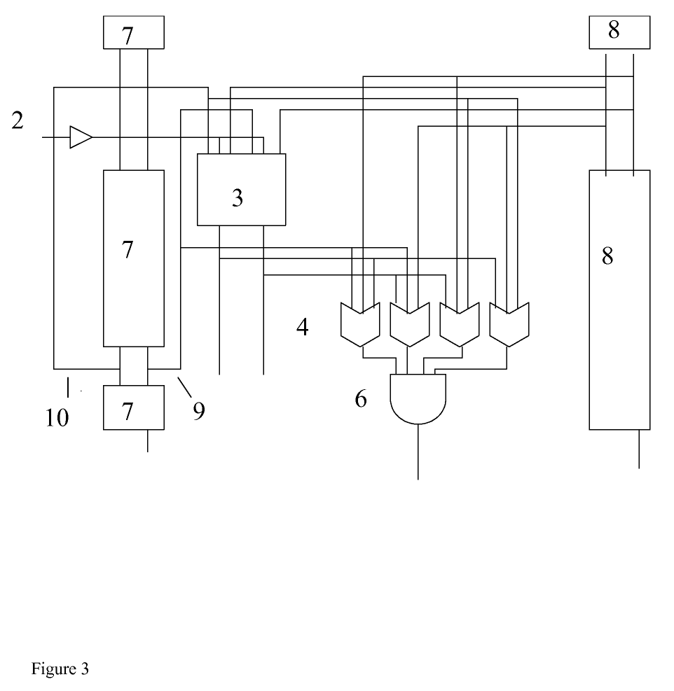

FIG. 3 is a schematic diagram of an Adder and shift registers embodying the principles of the present invention.

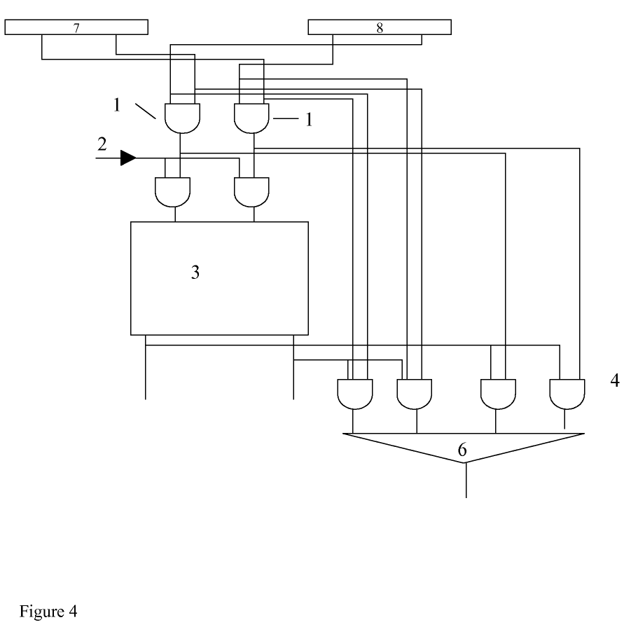

FIG. 4 is a schematic diagram of Adder embodying the principles of the present invention, as defined in claim 5.

FIG. 5 is a schematic diagram of shift registers with RS Flip Flops, which embodies the principles of the second, present invention, as defined in claim 5.

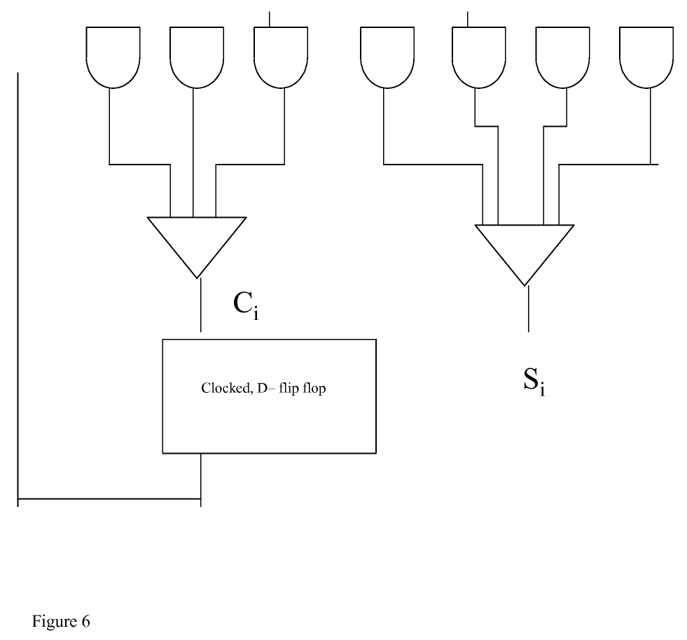

FIG. 6 is a schematic diagram of related-art serial adder with carry circuit.

The embodiments in which exclusive privilege is claimed comprises:

1. Circuitry for generating a carry signal, cᵢ, at the i^{th} place (of 2 bits, aᵢ and bᵢ) in the addition of 2 binary numbers, a and b, of length n, without separate calculation of the value of the previous carry, cᵢ₋₁. The circuitry comprises a single clocked R-S flip flop (FIG. 1.3), with an inverter (FIG. 1.2) for inhibiting the clock signal from entering said flip flop and further, two AND gates (FIG. 1. 1a) or, alternatively, dependent upon the accompanying embodiment of shift-register circuitry, an AND gate and OR gate, with inverter (FIG. 1. 1b), each of said gates comprising two input lines, means for applying data, and whose output terminals are applied to the flip flop, in whose Q terminal is stored cᵢ;

2. An embodiment of a digital, synchronous, serial adder (FIG. 2), which comprises two AND gates (FIG. 2. 1), the output terminal of each of which is applied to the data input terminals of an RS Flip Flop (FIG. 2. 3), comprising an input line for the clock signal with an inverter, which inhibits the clock signal from entering said Flip Flop (FIG. 2. 2) and comprising an And gate, means of combining data delivered thereto with output data from the Q^{c} terminal of said Flip Flop. The Q terminal of said Flip Flop, in whose output is stored the carry of two corresponding bits of two respective binary numbers, is an input to two AND gates (FIG. 2. 4), means to combine combinations of data bits with the carry signal from the previous bit pair. The output terminals of said three AND gates is an OR gate (FIG. 2. 6), in whose output is stored the sum.

3. Digital circuitry for “carry-less” serial addition, comprising circuitry for a digital, synchronous, serial adder, comprising 2 And gates (FIG. 4. 1), the output terminals of each of which is applied to the data input terminals of a clocked RS Flip Flop (FIG. 4. 3), as described in claim 1, and, additionally, 4 And gates (FIG. 4. 4) and an Or gate (FIG. 4. 6);

4. Digital circuitry for “carry-less” serial addition, comprising circuitry for a digital, synchronous, serial adder, comprising 2 And gates (FIG. 3. 1), the output terminals of each of which is applied to the data input terminals of a clocked RS Flip Flop (FIG. 3. 3), as described in claim 1, and, additionally, 4 Or gates (FIG. 3. 4) and an AND gate (FIG. 3. 6)).
In the embodiment, is also claimed:

5. And one shift register, said Register-B (FIG. 4. 7 and FIG. 5. 7), comprising means, comprising two lines (FIG. 3. 9 and FIG. 3. 10 and FIG. 5. 9 and FIG. 9. 10) for inputting data entering the B-register simultaneously to said Flip Flop (FIG. 4. 3), as defined in claim 1.

6. A binary algorithm for “non-carry,” addition of numbers (bₙ, bₙ₋₁, . . . ,b₀) and (aₙ, aₙ₋₁, . . . ,a₀) in Z,ⁿ⁺¹ by complementing 1's in “L-strings” of the form (dₖ, eₖ, eₖ₊₁, eₖ₊₂, . . . eᵣ,eᵣ₋₁) where dₖ=eₖ=eₖ₊₁=eₖ₊₂=. . . =eᵣ=1 and eᵣ₋₁=0 and where dᵢ=min (bᵢ, aᵢ) and eᵢ=max(bᵢ, aᵢ).
